(19) United States
(12) Patent Application Publication
(10) Pub. No.: US 2013/0319620 A1
(43) Pub. Date: Dec. 5, 2013

(54) BOARD SEPARATION APPARATUS AND OPERATING METHOD THEREOF

(71) Applicants: Chung W. Ho, Hsinchu County (TW); Shu-Ming Leu, Hsinchu County (TW)

(72) Inventors: Chung W. Ho, Hsinchu County (TW); Shu-Ming Leu, Hsinchu County (TW)

(73) Assignee: SUBTRON TECHNOLOGY CO., LTD., Hsinchu (TW)

(21) Appl. No.: 13/592,344

(22) Filed: Aug. 23, 2012

(30) Foreign Application Priority Data
Jun. 1, 2012 (TW) 101119818

(51) Int. Cl. B32B 38/10

(52) U.S. Cl. 156/714; 156/750

(57) ABSTRACT

A board separation apparatus and an operating method thereof are provided. The board separation apparatus includes a board separation machine and a composite board constituted of a plurality of circuit boards and carrier panels. The board separation machine includes a frame, first and second suction devices, and a linkage. The second suction device is positioned above the first suction device, and the composite board is placed in between the suction devices. The linkage connects the driving mechanism and second suction device. A separable interface layer is located in the composite board. When the suction devices are powered up to stick to the top and the bottom surfaces of the composite board, the linkage is pushed by the driving mechanism, so that the second suction device can move in relation to the first suction device, and one of the circuit board is separated from another one of the carrier panels.

### CROSS-REFERENCE TO RELATED APPLICATION

This application claims the priority benefit of Taiwan application serial no. 101119818, filed on Jun. 1, 2012. The entirety of the above-mentioned patent application is hereby incorporated by reference herein and made a part of this specification.

### BACKGROUND

1. Field of the Invention

The invention relates to a board separation apparatus and an operating method thereof for a composite board which includes one or more multilayer boards and one or more carrier panels bonded together, and more particularly to, a board separation apparatus for dissembling the circuit boards of a coreless substrate manufacturing process from the carrier panels and an operating method thereof.

2. Description of Related Art

In the semiconductor manufacturing process, the chip packaging substrate is one of the basic building blocks of the packaging components. The chip packaging substrate may be a multi-layer circuit board, which is constituted by alternatively stacking a circuit layer and a dielectric layer.

In general, the circuit layer and the dielectric layer in the multi-layer circuit board are built up on a core substrate with a certain thickness. Along with the development of thin electronic components, the thickness of the core substrate is reduced accordingly. However, with the reduction in the thickness of the core substrate, the degree of difficulty in handling, the failure rate of the substrate manufacturing process and the packaging process all increase due to insufficient rigidity of the thin core substrate.

Hence, by using the coreless process in the manufacture of the multi-layer circuit board, the problems arising in the substrate and the packaging process can be solved. In the coreless process, the core substrate is not used. A carrier panel serves as temporary support to form build-up circuit layers thereon. After the multi-layer circuit board is completed, it is separated from the carrier. In the conventional coreless process, the edges of the carrier and the edges of the multi-layer circuit board are bonded together. After the manufacturing processes are completed (e.g., etching, circuit lamination, or laser drill), the edges of the carrier bonded with the multi-layer circuit board are routed out leaving the multi-layer circuit board without the edge areas for the subsequent processes. However, a portion of the carrier and the multi-layer circuit board have to be cut in this conventional coreless process, the size of the multi-layer circuit board is reduced, and the carrier is not reusable.

### SUMMARY OF THE INVENTION

The invention provides a board separation apparatus for disassembling a plurality of boards of coreless process, so as to avoid problems caused by the boards of coreless process from cutting.

The invention provides an operating method of a board separation apparatus for operating the aforementioned board separation, so as to avoid problems caused by the boards of coreless process from cutting.

The invention provides a board separation apparatus for disassembling a composite board of coreless process. The board separation apparatus includes a board separation machine and a composite board, wherein the composite board includes a plurality of boards. The board separation machine includes a frame, a first suction device, a second suction device, a driving mechanism and a linkage. The first suction device is built into in the frame, and the second suction device is movable and is positioned above the first suction device by the linkage. An interface layer is located between the boards. After the composite board is placed between the first suction device and the second suction device to activate the suction, a vacuum is created between each of the suction devices and the corresponding surfaces of the composite board to bond together the devices to the two sides of the composite board, and the driving mechanism is used to force open the suction devices such that a board is separated from another board at the interface layer.

In an embodiment of the board separation apparatus, the second suction device is pivotally connected to the linkage so as to enable the second suction device to rotate in relative to the first suction device.

In an embodiment of the board separation apparatus, the first suction device includes a first main body and a first vacuum pump, and the second suction device includes a second main body and a second vacuum pump. The first main body has a first surface, a plurality of first suction holes and a plurality of first through holes. The first surface is located at the top of the first main body. The first suction holes are disposed in array at the first surface and perforated the first surface. The first suction holes are connected to the first through holes, and the first vacuum pump connects the first through holes. The second main body is pivotally connected to the linkage and has a second surface, a plurality of second suction holes and a plurality of second through holes. The second surface is located at the bottom of the second main body, and the second surface is located at an opposite side of the first surface. The second suction holes are disposed in array at the second surface and perforated the second surface. The second suction holes are connected to the second through holes, and the second vacuum pump connects the second through holes.

In an embodiment of the board separation apparatus, a first through hole extension axis of each first through hole is perpendicular to a first suction hole extension axis of each first suction hole, and a second through hole extension axis of each second through hole is perpendicular to a second suction hole extension axis of each second suction hole.

In an embodiment of the board separation apparatus, an orthogonal projection area of the first suction holes on the first surface is 509 mm×609.6 mm, and an orthogonal projection area of the second suction holes at the second surface is 509 mm×609.6 mm.

In an embodiment of the board separation apparatus, areas of each board include: 457 mm×610 mm, 508 mm×508 mm, 60 mm×140 mm and 50 mm×120 mm.

In an embodiment of the board separation apparatus, the first suction device and the second suction device respectively further include an O-ring, and each O-ring is respectively disposed around at the periphery of the first suction holes and the periphery of the second suction holes.

In an embodiment of the board separation apparatus, the boards include a carrier panel and a circuit board, wherein the carrier panel can be a aluminium board, a copper board, a stainless steel board or a core of a printed wiring board.

In an embodiment of the board separation apparatus, the boards include a carrier panel and a plurality of circuit boards, and the carrier panel is located between the circuit boards, wherein the carrier panel can be a aluminium board, a copper board, a stainless steel board or a core of a printed wiring board.

In an embodiment of the board separation apparatus, the interface layer between the boards is an adhesive.

In an embodiment of the board separation apparatus, the interface layer between the boards is an interface between an ultra-thin copper sheet and a carrier bearing the ultra-thin copper sheet.

In an embodiment of the board separation apparatus, the interface between the boards is an interface between a stainless steel and an electroplating copper.

In an embodiment of the board separation apparatus, an edge separation width is further presented between the boards. The edge separation width extends from the edge of the boards towards the inside of the boards.

In an embodiment of the board separation apparatus, a suction of the first suction device and a suction of the second suction device are greater than an adhesion of each interface layer.

In an embodiment of the board separation apparatus, the driving mechanism is a hydraulic cylinder.

The invention provides an operating method of a board separation apparatus suitable to be utilized in an application of a board separation from another board in a composite board. The board separation machine includes a frame, a first suction device, a second suction device, a driving mechanism and a linkage. The first suction device is assembled in the frame, and the second suction device is moved and is positioned above the first suction device by the linkage. An interface layer is located between the boards. The operating method of the board separation apparatus includes the following steps. Firstly, the second suction device is lowered into the top surface of the composite board, which is placed onto the first suction device such that the composite board is located between the first suction device and the second suction device. Next, the driving mechanism is driven by the oil pressure, so that the second suction device is moved relative to the first suction device, and the board is separated from the another board at the interface.

In an embodiment of the operating method of the board separation apparatus, the second suction device is pivotally connected to the linkage to enable the second suction device to rotate in relation to the first suction device.

According to the above, the invention utilizes two suction devices (viz., the first suction device and the second suction device) to suck two sides of the composite board, and the driving mechanism drives up the second suction device, so as to separate one of the boards from anther one of the boards. In this manner, the boards do not have to be cut, and a reduction of the size of the boards may be avoided. Therefore the board after the disassembling may be reused.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a side view of a board separation apparatus according to an embodiment of the invention.

FIG. 2 is a cross-sectional view of two suction boxes in FIG. 1.

FIG. 3 is a top view of a first suction device in FIG. 1.

FIG. 4 is a side view of the first suction device in FIG. 3.

FIG. 5 is a partial enlarged view of the first suction device illustrated in FIG. 3 at a part B.

FIG. 6 is a cross-sectional view of a composite board installed at two suction boxes according to another embodiment of the invention.

FIG. 7 is a flow chart of an operating method of a board separation apparatus according to an embodiment of the invention.

### DETAILED DESCRIPTION OF DISCLOSED EMBODIMENTS

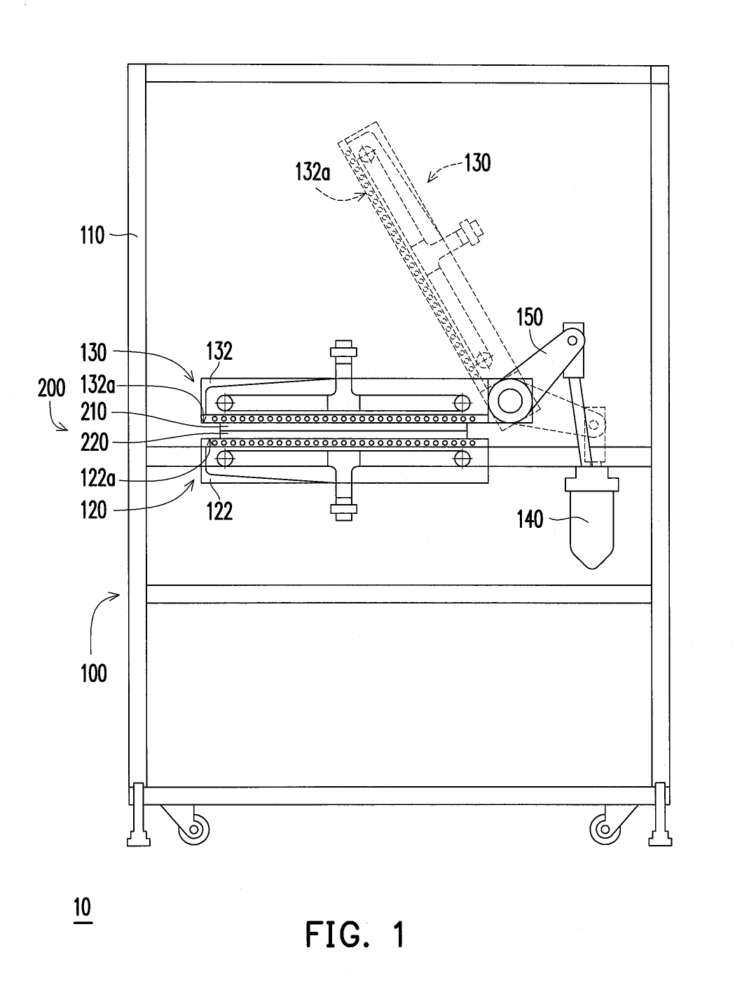

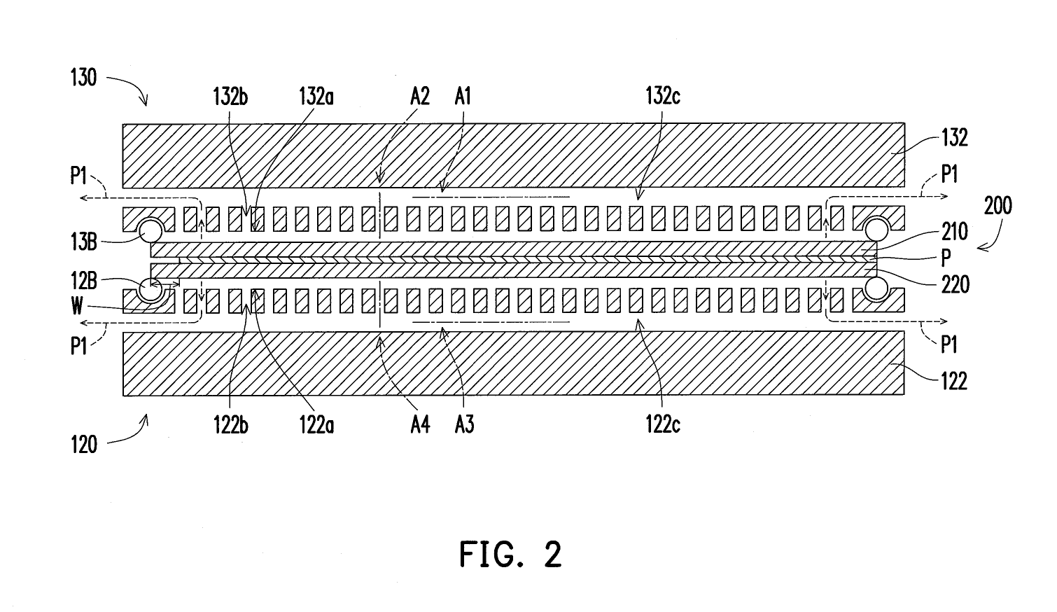

FIG. 1 is a side view of a board separation apparatus according to an embodiment of the invention. FIG. 2 is a cross-sectional view of two suction boxes in FIG. 1. Referring to FIG. 1 and FIG. 2, in the present embodiment, a board separation apparatus 10 may be utilized to disassemble a composite board 200 produced by a coreless process. The board separation apparatus 10 includes a board separation machine 100 and the composite board 200, wherein the composite board 200 of the present embodiment may be constitute of a plurality of boards which include a carrier panel 210 and a circuit board 220, and the carrier panel 210 is utilizes to provide support to the circuit board 220 during multiple processes (e.g., etching, circuit lamination, or laser drill). In addition, the carrier panel 210 of the present embodiment can be an aluminium board, a copper board, a stainless steel board or a core of a printed wiring board.

Accordingly, the board separation machine 100 includes a frame 110, a first suction device 120, a second suction device 130, a driving mechanism 140 and a linkage 150. The first suction device 120 is assembled in the frame 110, and the second suction device 130 sits on top of the first suction device 120. The linkage 150 connects the driving mechanism 140 and the second suction device 130. The driving mechanism 140 can be, for example, a hydraulic cylinder capable of forcing a movement of the linkage 150. A separable interface layer P is located between the carrier panel 210 and the circuit board 220, and the carrier panel 210 may be bonded with the circuit board 220 through the interface layer P. Furthermore, the interface layer P of the present embodiment may, for example, be a silicone adhesive, an interface layer between an ultra-thin copper sheet and its copper foil carrier, an interface between a stainless steel and an electroplated copper, or other interface capable of separating or bonding the carrier panel 210 and the circuit board 220. When the second suction device 130 closes on the first suction device 120 and the composite board 200 is placed between them with a vacuum created in the suction devices by pumping out the air, the linkage 150 is then driven by the driving mechanism 140, so that the second suction device 130 can move in relation to the first suction device 120, and the carrier panel 210 of the composite board 200 is separated from the circuit board 220 of the composite board 200.

In detail, since a suction force of the first suction device 120 and a suction force of the second suction device 130 to the two sides of the composite board 200 are greater then the adhesion of the interface layer P, the carrier panel 210 to the circuit board 220, the power provided by the driving mechanism 140 is greater than the adhesion of the interface layer P, the carrier panel 210 is separated from the circuit board 220, and the second suction device 130 (e.g., a part enclosed by dashed-lines in FIG. 1) is moving along a direction away from the first suction device 120.

Hence, the circuit board 220 and the carrier panel 210 do not have to be cut, and a reduction of the size of the circuit board 220 may be avoided. In addition, since the carrier panel 210 is not cut, the carrier panel 210 may be reused, and thus is helpful in lowering a production cost of coreless process.

Furthermore, an edge separation width W is presented between the boards, wherein the edge separation width W extends from the edge of the boards towards the inside of the boards. Through the formation of the edge separation width W, the adhesion of the interface layer P may be weakened so as to lower the force of separating the carrier panel 210 and the circuit board 220.

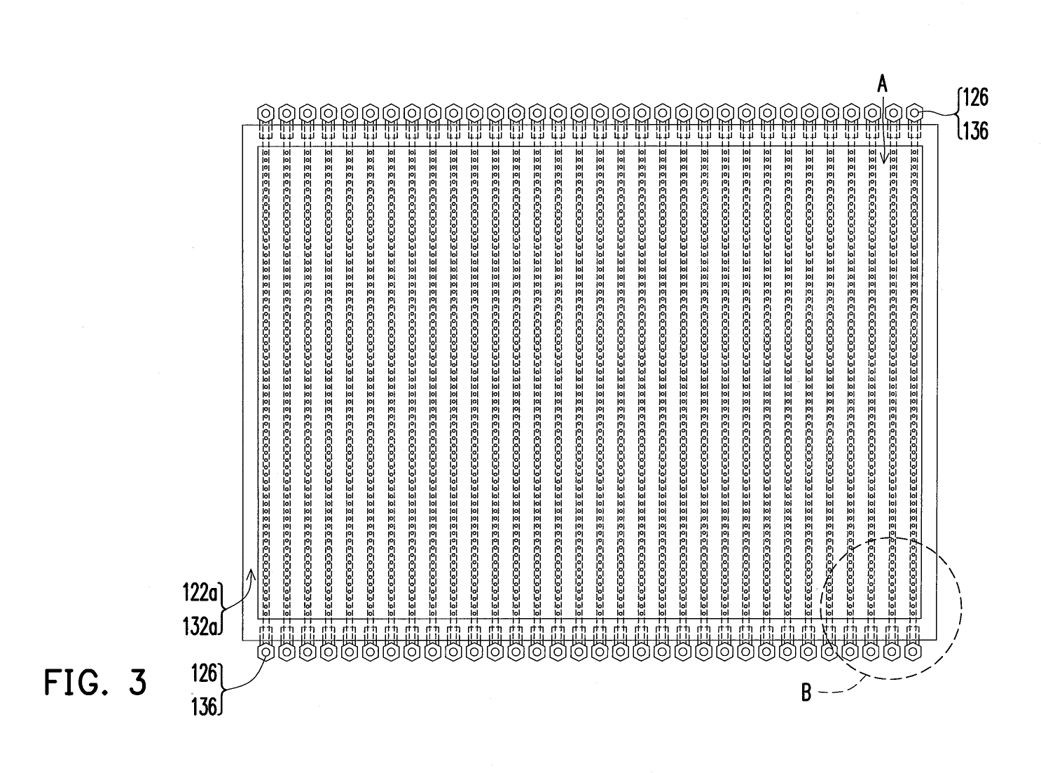

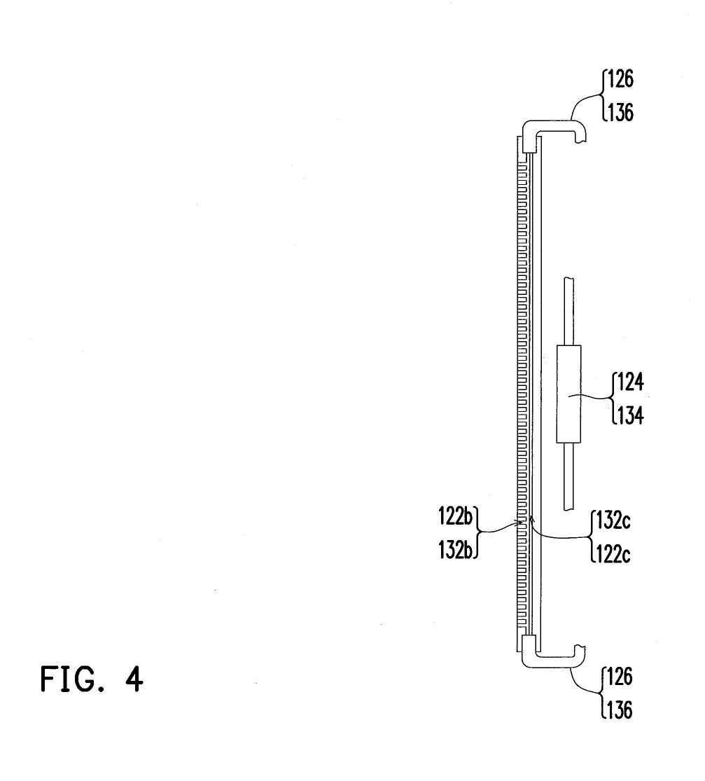

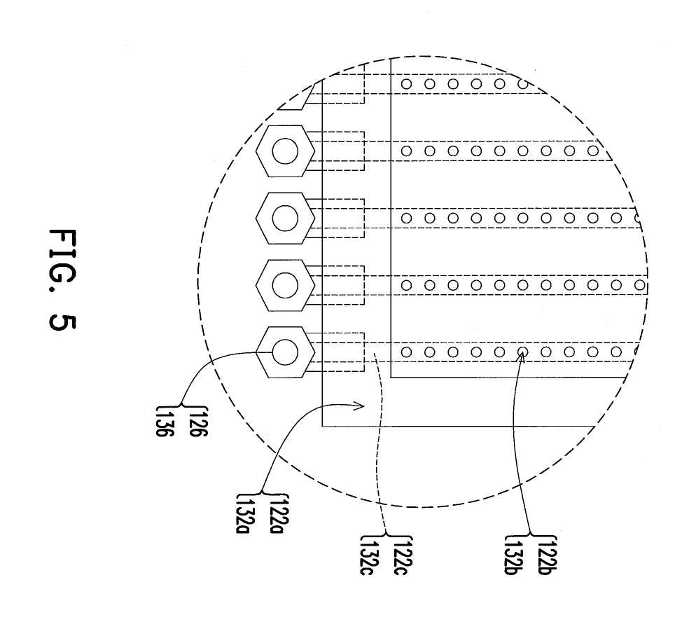

FIG. 3 is a top view of a first suction device in FIG. 1. FIG. 4 is a side view of the first suction device in FIG. 3. FIG. 5 is a partial enlarged view of the first suction device illustrated in FIG. 3 at a part B. Referring to FIG. 3, FIG. 4 and FIG. 5, it is to be explained that since the second suction device 130 is similar to the first suction device 120, descriptions of both the first suction device 120 and the second suction device 130 are provided with references to FIG. 3, FIG. 4 and FIG. 5, and also, with references to FIG. 1 and FIG. 2. In addition, to make simple of the drawing, FIG. 4 only illustrates parts of the components of the first suction device 120.

Accordingly, the first suction device 120 of the present embodiment includes a first main body 122 and a first vacuum pump 124, and the second suction device 130 of the present embodiment includes a second main body 132 and a second vacuum pump 134. The first main body 122 has a first surface 122a, a plurality of first suction holes 122b and a plurality of first through holes 122c. The first surface 122a is located at the top of the first main body 122. The first suction holes 122b are disposed in array at the first surface 122a and perforated the first surface 122a. The first suction holes 122b are connected to the first through holes 122c, and the first vacuum pump 124 connects two ends of the first through holes 122c through a plurality of connecting tubes 126.

The second main body 132 is pivotally connected to the linkage 150 and has a second surface 132a, a plurality of second suction holes 132b and a plurality of second through holes 132c. The second surface 132a is located at the bottom of the second main body 132, and the second surface 132a is located at an opposite side of the first surface 122a. The second suction holes 132b are disposed in array at the second surface 132a and perforated the second surface 132a. The second suction holes 132b are connected to the second through holes 132c, and the second vacuum pump 134 connects two ends of the second through holes 132c through a plurality of connecting tubes 136. Moreover, a first through holes extension axis A1 of each first through holes 122c is perpendicular to a first suction hole extension axis A2 of each first suction hole 122b, and a second through holes extension axis A3 of each second through holes 132c is perpendicular to a second suction hole extension axis A4 of each second suction hole 132b.

Therefore, air between the first main body 122 and the second main body 132 are exhausted along a path P1 after being extracted by the first vacuum pump 124 and the second vacuum pump 134, and thus a vacuum state is formed between the first main body 122 and the second main body 132, so as to enable the carrier panel 210 to be sucked to the second suction device 130 and the circuit board 220 to be sucked to the first suction device 120.

In addition, the first suction device 120 and the second suction device 130 of the present embodiment respectively further include an O-ring 128, 138, and each O-ring 128, 138 is respectively disposed around at the periphery of the first suction holes 122b and the periphery of the second suction hole 132b. With the configuration described above, it is helpful in sealing the first main body 122 and the second main body 132 in order to avoid gas flowing into the interiors of the first main body 122 and the second main body 132 and weakening the vacuum state.

Referring to FIG. 3 and FIG. 5, the first suction holes 122b and the second suction holes 132b of the present embodiment are respectively disposed in array at the first surface 122a and the second surface 132a, and are respectively having an orthogonal projection area A. Wherein, the size of the orthogonal projection area A of the first suction holes 122b and the size of the orthogonal projection area A of the second suction holes 132b are both 509 mm×609.6 mm. With the configuration described above, the invention may be applied to different sizes of the composite boards 200 (viz., the boards of different sizes). For example, areas of the boards may include 457 mm×610 mm, 508 mm×508 mm, 60 mm×140 mm, and 50 mm×120 mm.

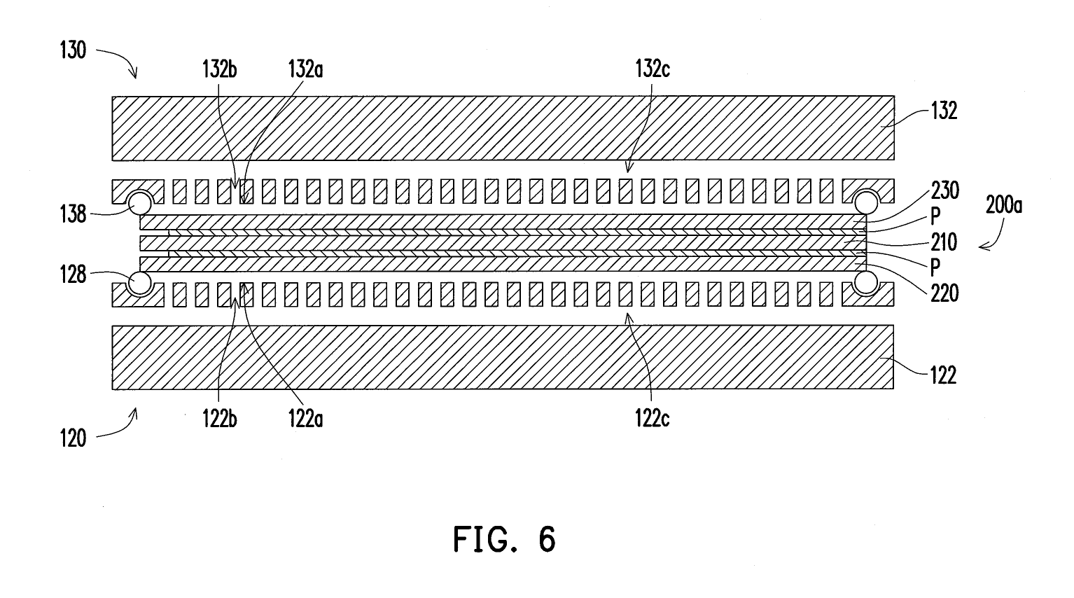

FIG.6 is a cross-sectional view of a composite board installed at two suction boxes according to another embodiment of the invention. Referring to FIG. 2 and FIG.6, a composite board 200a of the present embodiment is similar to the composite board 200 in FIG. 2; therefore, the following below only describes differences between the two embodiments, wherein the same notations are used for representing the same or similar components, and thus is not repeated herein. In the present embodiment, the composite board 200a includes a carrier panel 210 and two circuit boards 220, 230. The carrier panel 210 is located between the circuit boards 220, 230, and the carrier panel 210 is bonded with the circuit boards 220, 230 through a plurality of interface layers P. When the circuit board 220 is fixed through being sucked by a first suction device 120 and the circuit board 230 is fixed through being sucked by a second suction device 130, a driving mechanism 140 drives a linkage 150 to push up the second suction device 130 to rotate in relative to the first suction device 120, and the circuit board 230 may be separated from the carrier panel 210 and the circuit board 220. Similarly, after the circuit board 230 is disassembled, the above steps are repeated so as to separate the circuit board 220 from the carrier panel 210. With the above steps, the invention may be applied to disassemble plurality of circuit boards.

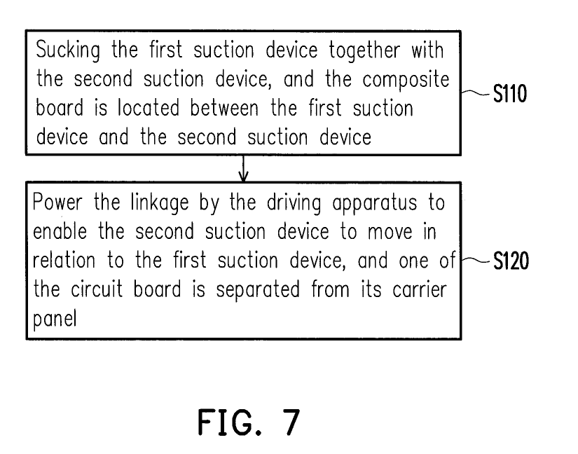

FIG. 7 is a flow chart of an operating method of a board separation apparatus according to an embodiment of the invention. Referring to FIG. 1, FIG. 2 and FIG. 7, in the present embodiment, the operating method of the board separation apparatus is suitable to be utilized in an application of a board separation apparatus 10 to disassemble a composite board 200 of the coreless process. The board separation apparatus 10 includes a board separation machine 100 and the composite board 200, wherein the composite board 200 may be constituted by a plurality of boards which include the carrier panel 210 and the circuit board 220. The board separation machine 100 includes a frame 110, a first suction device 120 assembled in the frame 110, a second suction device 130, a driving mechanism 140, and a linkage 150 connecting the second suction device 130 and the driving mechanism 140. A separable interface layer P is located between the boards, and each board is bonded by the interface layer P. The operating method of the board separation apparatus includes the following steps. Firstly, in step S110, the first suction device 120 is powered up with the second suction device 130 to pump out the air between the boxes, and the composite board 200 is placed between the first suction device 120 and the second suction device 130. Next, in step S120, the driving mechanism 140 drives the linkage 150 to enable the second suction device 130 to move in relation to the first suction device 120, so that the circuit board 220) of the boards is separated from another one (such as the carrier panel 210) of the boards. In this manner, the operating method may be applied to disassemble a plurality of circuit boards from carrier panels of coreless process. Hence, the composite board 200 do not have to be cut, the sizes of the circuit boards may be maintained, and the carrier panels may be reused.

The operating method of the board separation apparatus of the present embodiment may enable the second suction device 130 to rotate in relation to the first suction device 120 by pivotally connecting the second suction device 130 to the linkage 150. Hence, a force of separating the carrier panel 210 and the circuit boards 220, 230 may be lowered, and an output power of the driving mechanism 140 may be reduced.

In summary, the invention utilizes the first suction device and the second suction device to separate a composite board by using the driving mechanism through the linkage in order to push to the second suction device and the first suction device to move in relation to each other, so that the circuit board and the carrier panel are separated from each other. In this manner, a reduction in the size of the circuit boards may be avoided, and the carrier panel may be reused, such that it is helpful in reducing the production cost of the coreless process. In addition, the first suction device and the second suction device can rotate in relation to each other, capable of lowering the force of separating the carrier panel and the circuit board, and therefore reduces the output power of the driving mechanism. Moreover, when the edge separation width is presented between the boards, the adhesion of the interface layer is weakened, and thus is helpful in disassembling the boards.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A board separation apparatus comprising:
a board separation machine comprising:
a frame;
a first suction device, assembled in the frame;
a second suction device, aligned to and on top of the first suction device;
a driving mechanism;
a linkage, connecting the driving mechanism and the second suction device; and
a composite board comprising a plurality of boards, wherein an interface layer is used to bond the boards, and when the first suction device and the second suction device are sucked together and the composite board is located in between, the linkage is driven by the driving mechanism, so that the second suction device can move in relative to the first suction device, and one of the boards is separated from another one of the boards.

2. The board separation apparatus as claimed in claim 1, wherein the second suction device is pivotally connected to the linkage to enable the second suction device to rotate in relation to the first suction device.

3. The board separation apparatus as claimed in claim 1, wherein the first suction device comprises a first main body and a first vacuum pump, and the second suction device comprises a second main body and a second vacuum pump; the first main body has a first surface, a plurality of first suction holes and a plurality of first through holes, wherein the first surface is located at the top of the first main body, the first suction holes are disposed in array at the first surface and perforated the first surface, the first suction holes are connected to the first through holes, and the first vacuum pump connects the first through holes; the second main body is pivotally connected to the linkage and has a second surface, a plurality of second suction holes and a plurality of second through holes, wherein the second surface is located at the bottom of the second main body and located at an opposite side of the first surface, the second suction holes are disposed in array at the second surface and perforated the second surface, the second suction holes are connected to the second through holes, and the second vacuum pump connects the second through holes.

4. The board separation apparatus as claimed in claim 3, wherein a first through hole extension axis of each first through hole is perpendicular to a first suction hole extension axis of each first suction hole, and a second through hole extension axis of each second through hole is perpendicular to a second suction hole extension axis of each second suction hole.

5. The board separation apparatus as claimed in claim 3, wherein an orthogonal projection area of the first suction holes on the first surface is 509 mm×609.6 mm, and an orthogonal projection area of the second suction holes at the second surface is 509 mm×609.6 mm.

6. The board separation apparatus as claimed in claim 5, wherein areas of each board comprise: 457 mm×610 mm, 508 mm×508 mm, 60 mm×140 mm, and 50 mm×120 mm.

7. The board separation apparatus as claimed in claim 5, wherein the first suction device and the second suction device respectively further comprise an O-ring, and each O-ring is respectively disposed around at the periphery of the first suction holes and the periphery of the second suction holes.

8. The board separation apparatus as claimed in claim 1, wherein the boards comprise a carrier panel and a circuit board.

9. The board separation apparatus as claimed in claim 8, wherein the carrier panel is a aluminium board, a copper board, a stainless steel board or a core of a printed wiring board.

10. The board separation apparatus as claimed in claim 1, wherein the boards comprise a carrier panel and a plurality of circuit boards, and the carrier panel is located between the circuit boards.

11. The board separation apparatus as claimed in claim 10, wherein the carrier panel is a aluminium board, a copper board, a stainless steel board or a core of a printed wiring board.

12. The board separation apparatus as claimed in claim 1, wherein the interface layer between the boards is an adhesive.

13. The board separation apparatus as claimed in claim 1, wherein the interface layer between the boards is an interface between an ultra-thin copper sheet and a carrier bearing the ultra-thin copper sheet.

14. The board separation apparatus as claimed in claim 1, wherein the interface layer between the boards is an interface between a stainless steel and an electroplating copper.

15. The board separation apparatus as claimed in claim 1, wherein an edge separation width is further presented between the boards, and the separation width extends from the edge of the boards towards the inside of the boards.

16. The board separation apparatus as claimed in claim 1, wherein a suction of the first suction device and an suction of the second suction device to the board are greater than an adhesion of each interface layer.

17. The board separation apparatus as claimed in claim 1, wherein the driving mechanism is a hydraulic cylinder.

18. An operating method of a board separation apparatus, suitable to be utilized in an application of a board separation machine and a composite board, wherein the composite board comprises a plurality of boards, the board separation machine comprises a frame, a first suction device assembled in the frame, a second suction device aligned to and on top of the first suction device, a driving mechanism, and a linkage connecting the second suction device and the driving mechanism, wherein an interface layer is located between the boards, and each board is bonded by each interface layer; and the operating method of the board separation apparatus comprising:
sucking the first suction device together with the second suction device, and the composite board is located between the first suction device and the second suction device; and
driving the linkage by the driving mechanism to enable the second suction device to move in relation to the first suction device, and one of the boards is separated from another one of the boards.

19. The operating method of the board separation apparatus as claimed in claim 18, wherein through pivotally connecting the second suction device to the linkage, the second suction device can rotate in relation to the first suction device.
